(19) United States
(12) Patent Application Publication
(10) Pub. No.: US 2022/0288829 A1
(43) Pub. Date: Sep. 15, 2022

(54) INJECTION MOLDING DEVICE

(71) Applicant: HONDA MOTOR CO., LTD., Tokyo (JP)

(72) Inventor: Hiroshi MATSUSHIMA, Tochigi (JP)

(21) Appl. No.: 17/608,156

(22) PCT Filed: May 28, 2020
(86) PCT No.: PCT/JP2020/021095

§ 371 Date: Nov. 2, 2021

(30) Foreign Application Priority Data
May 29, 2019 (JP) 2019-100441

(51) Int. Cl. B29C 45/74; B29C 45/28; B29C 45/27

(52) U.S. Cl. CPC B29C 45/74; B29C 45/2806; B29C 45/278

(57) ABSTRACT

A hot runner-type injection structure 4 is provided with: a hot runner nozzle 5; and a valve pin 6 that is provided to be able to advance and retreat in the axial line O1 direction inside the flow passage of the hot runner nozzle 5 and that opens/closes the flow passage by coming into contact/being spaced apart from a valve opening/closing part 13 which has a tip part disposed on the tip side of the hot runner nozzle 5, wherein a heat insulating groove 16, which is recessed inward toward the axial line O1 side from an outer circumferential surface and extends in the circumferential direction, is provided on the outer periphery in a valve pin contact section M in which the valve opening/closing part 13 of the hot runner nozzle 5 is formed.

### TECHNICAL FIELD

The present invention relates to an injection molding device.

### BACKGROUND ART

Conventionally, an injection molding method (injection molding device) has been frequently used, since the method (device) can efficiently produce a large amount of complex-shaped molded products.

An injection molding device includes: a mold clamping device that opens/closes and clamps a pair of molds 1 and 2 (fixed mold 1 and movable mold 2) by moving a movable platen (movable platen) relative to a fixed platen (fixed platen); and an injection device 3 that injects a molding material such as molten resin into a cavity H of the pair of clamped molds 1 and 2 (see FIG. 1).

The fixed mold 1 includes an injection structure 4 for injecting the molding material from the injection device 3 into the cavity H; and the injection structure 4 can be categorized into two major systems: a hot runner system and a cold runner system.

As illustrated in FIG. 5 (FIG. 1), the injection structure (valve gate structure) 4 of a hot runner system includes: a hot runner nozzle 5 having a flow path communicating with the cavity H; a valve 6 for opening and closing the flow path of the hot runner nozzle 5; and a manifold (hot runner block) 7 having a flow path communicating with the flow channel of the hot runner nozzle 5, in which a molding material R is supplied from the injection device 3 to the flow path of the manifold 7, from the flow path of the manifold 7 to the flow path of the hot runner nozzle 5, and from the flow path of the hot runner nozzle 5 to the cavity H of the molds 1 and 2.

The hot runner nozzle 5 includes a heating part 8 such as an electric heater on the periphery, allowing for maintaining a molten state of the molding material R injected from the injection device 3. The fixed mold 1 internally includes a cooling part (refrigerant flow path) 9 for supplying a refrigerant and cooling and curing the molding material R injected.

Here, Japanese Unexamined Patent Application, Publication No. 2016-087817 discloses “a valve gate device comprising: a nozzle formed at a tip thereof, the nozzle including a discharge port for discharging molten resin toward a cavity; and a gate opening/closing pin which is axially moved with respect to the nozzle to open/close a gate, wherein a heat insulation groove is formed in at least part of a periphery of the discharge port at the tip”.
Patent Document 1: Japanese Unexamined Patent Application, Publication No. 2016-087817

### DISCLOSURE OF THE INVENTION

### Problems to be Solved by the Invention

As illustrated in FIGS. 5 and 6A, the cooling part 9 for supplying a refrigerant into the fixed mold 1 and cooling the injected molding material R coexists with the heating part 8 of the hot runner nozzle 5, at the tip portion P of the hot runner nozzle 5 of the conventional injection molding device described above.

Thus, as illustrated in FIG. 6B (FIGS. 5 and 6A), it is difficult to adjust or control temperature of the tip portion P of the hot runner nozzle 5, involving disadvantages such as slag (resin mass) remaining on the inner wall of the nozzle if the temperature of the portion P is excessively low, or stringiness of the molding material R elongated in stringy form at the nozzle tip of the discharge port 10 if the temperature is excessively high. In other words, when the cooling part 9 and the heating part 8 coexist in the portion P at the nozzle tip, toughness (temperature adjustment range) against causing stringiness or slag is reduced, creating uncertainty (indicated as “?” in FIG. 6B).

Therefore, there has been a strong demand to develop a method of maintaining a preferable temperature range, allowing for adjusting or controlling temperature of the nozzle tip portion without excessively decreasing or increasing the temperature.

### Means for Solving the Problems

One aspect of the injection molding device of the present invention is an injection molding device (e.g., injection molding device A described below) including an injection structure (e.g., injection structure 4 described below) of a hot runner system for injecting a molding material (e.g., molding material R described below) into a cavity (e.g., cavity H described below) of a fixed mold (e.g., fixed mold 1 described below) and a movable mold (e.g., movable mold 2 described below) both clamped, in which the injection structure includes: a hot runner nozzle (e.g., hot runner nozzle 5 described below) including a heating part on an outer circumferential side, and a flow path extending from a rear end to a tip in an axial direction (e.g., axial O1 direction described below) and communicating with the cavity; and a valve pin (e.g., valve pin 6 described below) arranged in the flow path of the hot runner nozzle, the valve pin capable of advancing/retracting in the axial direction, in which a tip of the valve pin contacts with or separates from a valve opening/closing part (e.g., valve opening/closing part 13 described below) provided on a tip side of the hot runner nozzle, thereby closing or opening the flow path, in which a heat insulation groove (e.g., heat insulation groove 16 described below) is provided to an outer circumference of a valve pin contact section (e.g., valve pin contact section M described below), in which the valve opening/closing part of the top nozzle is formed, the heat insulation groove being recessed inward from an outer circumferential surface toward the axial line and extending in a circumferential direction.

### Effects of the Invention

According to the aspect of the injection molding device of the present invention, providing the heat insulation groove allows for adjusting or controlling temperature of the tip of the hot runner nozzle, preventing the temperature from being excessively low or high, and preferably eliminating disadvantages such as slag remaining on the inner wall of the nozzle or stringiness occurring in the discharge port of the nozzle tip.

### BRIEF DESCRIPTION OF THE DRAWINGS

FIG. 1 is a cross-sectional view illustrating an injection structure of an injection molding device according to an embodiment of the present invention;

FIG. 2 is an enlarged view illustrating a portion denoted by a reference mark S in FIG. 1, and is a cross-sectional view illustrating the injection structure (valve gate structure) of the injection molding device according to the embodiment of the present invention;

FIG. 3 is an enlarged view illustrating the portion denoted by the reference mark S in FIG. 1, and is a cross-sectional view illustrating a modification example of the injection structure (valve gate structure) of the injection molding device according to the embodiment of the present invention;

FIG. 4 is an enlarged view illustrating the portion denoted by the reference mark S in FIG. 1, and is a cross-sectional view illustrating another modification example of the injection structure (valve gate structure) of the injection molding device according to the embodiment of the present invention;

FIG. 5 is a cross-sectional view illustrating a modification example of an injection structure (valve gate structure) of a conventional injection molding device;

FIG. 6A is a cross-sectional view illustrating another modification example of the injection structure (valve gate structure) of the conventional injection molding device; and FIG. 6B is a graph illustrating a relationship between temperature of a molding material and generation of stringiness and slag, also illustrating a preferable temperature control range of a portion denoted by a reference mark P (a tip side portion of a hot runner nozzle) in FIG. 6A.

### PREFERRED MODE FOR CARRYING OUT THE INVENTION

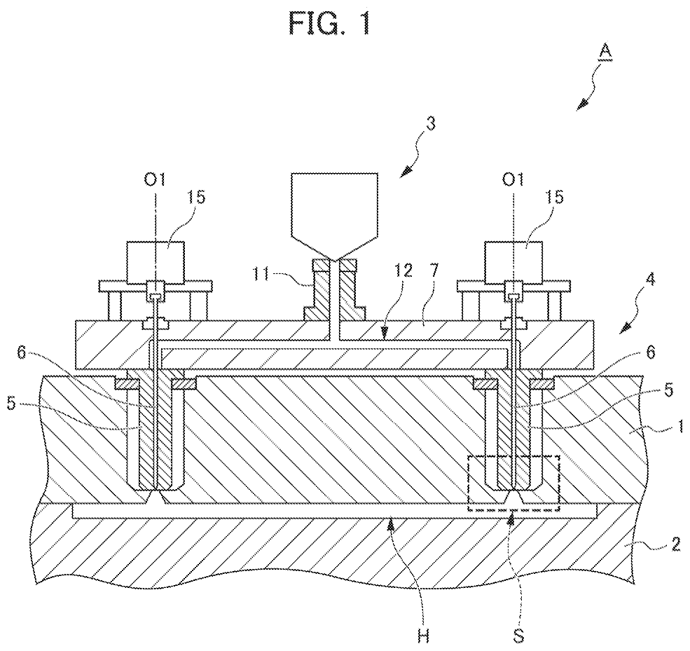

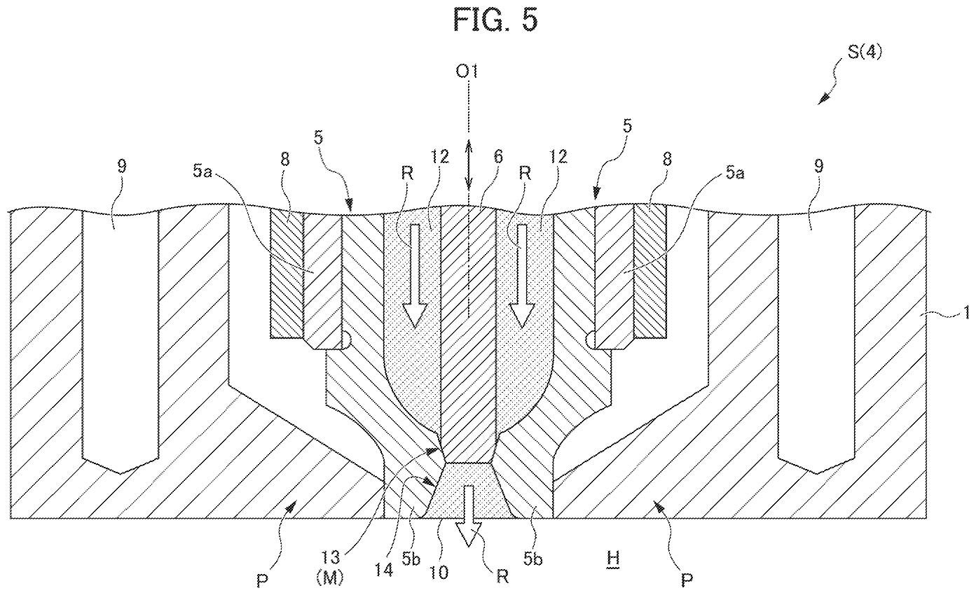

Referring to FIGS. 1 to 5, an injection molding device according to an embodiment of the present invention will be described. Here, the present embodiment relates to an injection molding device having an injection structure of a hot runner system.

As illustrated in FIG. 1, an injection molding device A of the present embodiment includes: a mold clamping device that opens/closes and clamps a pair of molds 1 and 2 (fixed mold 1 and movable mold 2) by moving a movable platen (movable platen) relative to a fixed platen (fixed platen); an injection device 3 that injects a molding material R such as molten resin into a cavity H of the pair of clamped molds 1 and 2; and an ejecting device that takes out a molded product from the molds 1 and 2, the ejecting device including an ejecting pin, an ejecting drive part and the like.

The injection device 3 includes: a tubular heating cylinder having a screw coaxially arranged inside; a heating part such as an electric heater for melting the molding material R, the heating part provided on an outer circumference of the heating cylinder; an injection nozzle for injecting the molding material R supplied by way of rotation of the screw provided on the tip side of the heating cylinder; and a material supply part such as a hopper for supplying the molding material R into the heating cylinder, the material supply part provided on the rear end side of the heating cylinder.

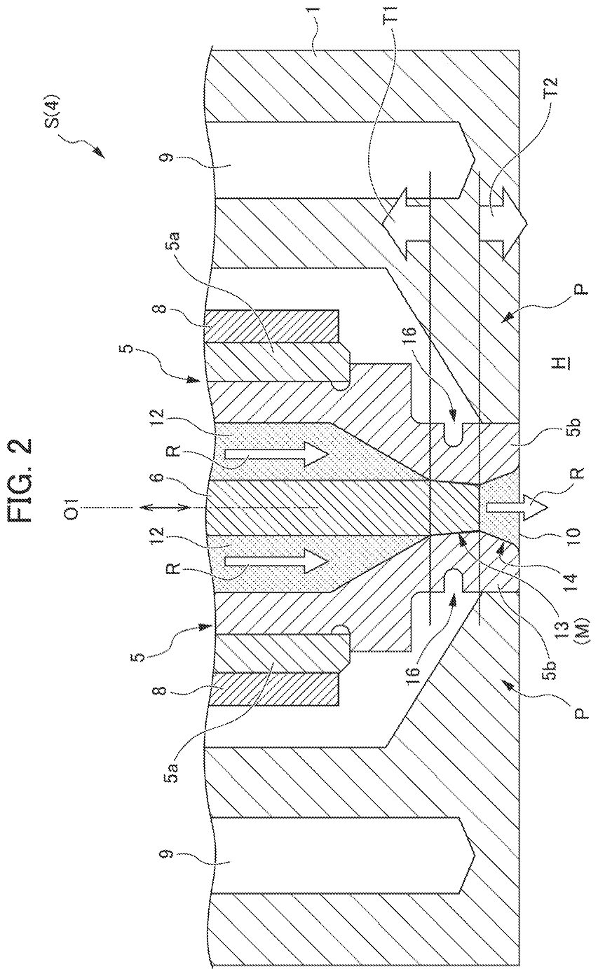

On the other hand, as illustrated in FIGS. 1 and 2, the fixed mold 1 includes an injection structure (valve gate structure) 4 of a hot runner system for injecting the molding material R from the injection device 3 into the cavity H.

The injection structure 4 of a hot runner system includes: one or more hot runner nozzles 5 provided to the fixed mold 1 and including a flow path communicating with the cavity H; a valve 6 for opening and closing the flow path of the hot runner nozzle 5; a sprue 11 connected to the injection device 3 and supplied with the molding material R; a manifold (hot runner block) 7 provided to a portion of the fixed mold 1 between the sprue 11 and the hot runner nozzle 5 and including a flow path that communicates with the flow path of the hot runner nozzle 5 and the flow path of the sprue 11, in which the flow path of the sprue 11, the flow path of the manifold 7, and the flow path of the hot runner nozzle 5 form a molding material flow path 12 in series, through which the molding material R is supplied from the injection device 3 to the cavity H.

The hot runner nozzle 5 and the sprue 11 include a heating part such as an electric heater on the periphery, allowing for heating the molding material R injected from the injection device 3 and maintaining a predetermined molten state.

The hot runner nozzle 5 of the present embodiment includes, for example: a nozzle body 5a formed in a tubular shape, through which the molding material R circulates from the rear end side to the tip by rotation of the screw; and a top nozzle 5b attached to the tip of the nozzle body 5a.

In the top nozzle 5b (hot runner nozzle 5), the flow path for the molding material R is narrowed in diameter to a predetermined flow path area, and a valve pin 6 (to be described later) is driven to advance/retract in an axial O1 direction, whereby the tip of the valve pin 6 engages/disengages (contacts/separates); and the top nozzle 5b includes a valve opening/closing part (throttle part) 13 for opening/closing the flow path, and a discharge part 14 as a flow path from the valve opening/closing part 13 to the discharge port 10 at the tip, the discharge part 14 formed so as to provide a desired injection performance.

The valve pin 6 internally included in the hot runner nozzle 5 is driven by the drive source 15 to advance/retract in the axial O1 direction; the valve pin 6 advances to contact with the inner surface of the valve opening/closing part 13 and closes the flow path of the valve opening/closing part 13; and the valve pin 6 retracts and opens the flow path of the valve opening/closing part 13. The position of the valve pin 6 can adjust the degree of opening of the flow path, whereby the injection volume and injection velocity of the molding material R can be adjusted.

A cooling part 9 is provided, which supplies a refrigerant into the fixed mold 1 and cools the molding material R injected into the cavity H as well as the portion from the valve opening/closing part 13 to the cavity H.

On the other hand, the injection structure 4 of the injection molding device A of the present embodiment includes a heat insulation groove (heat insulation hole) 16, which is recessed inward from the outer circumferential surface toward the axial line O1 and extends in the circumferential direction, on the outer circumference of a section (valve pin contact section) M in the axial O1 direction, in which the valve opening/closing part 13 of the top nozzle (nozzle tip component) 5b of a hot runner system and a valve gate system is formed.

The heat insulation groove 16 as such is provided to the valve pin contact section M of the top nozzle 5b, whereby a region in which the molding material R is desired to be maintained in a molten state by the heating part 8 (region to maintain a high temperature state/molding material heat-insulating layer) T1 is thermally insulated from a region in which the molding material R and a molded product are desired to be cooled to solidify by the cooling part 9 (region to maintain a low temperature state/molding material cooling layer) T2, whereby the molding material heat-insulating layer T1 and the molding material cooling layer T2 can be clearly distinguished.

Therefore, with the injection structure 4 of the injection molding device A of the present embodiment, while the molding material R flows inside the fixed mold 1, the molding material R before the valve pin contact section M, i.e., the molding material R toward the surface of contact between the top nozzle 5b and the valve pin 6 can be reliably maintained in a molten state by the heating part 8, and the molding material R from the valve pin contact section M toward the cavity H can be reliably solidified by the cooling part 9 in the forming step.

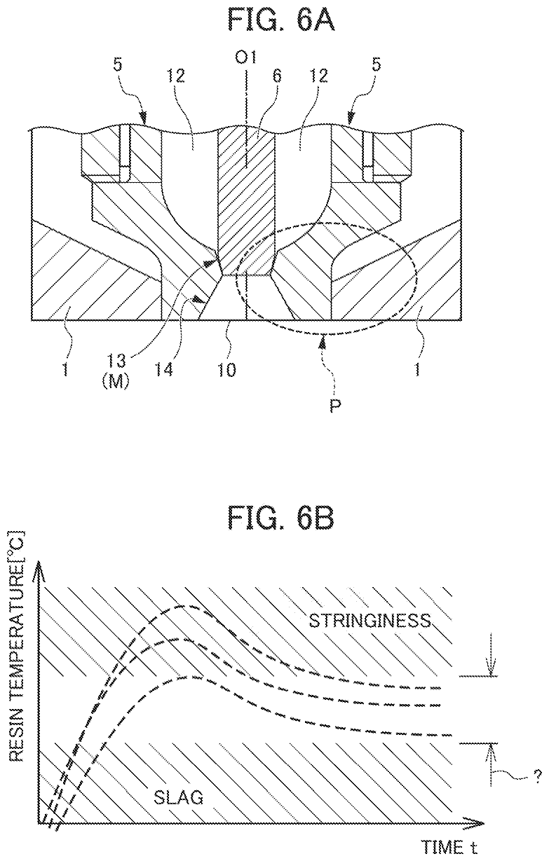

As a result, the injection structure 4 of the injection molding device A of the present embodiment can achieve preferred temperature control of a molding material as illustrated in FIG. 6B, and effectively suppress stringiness and slag from being generated.

The embodiment of the injection molding device according to the present invention has been described above; however, the present invention is not limited to the above-mentioned embodiment and can be appropriately modified within a range that does not deviate from the spirit of the present invention.

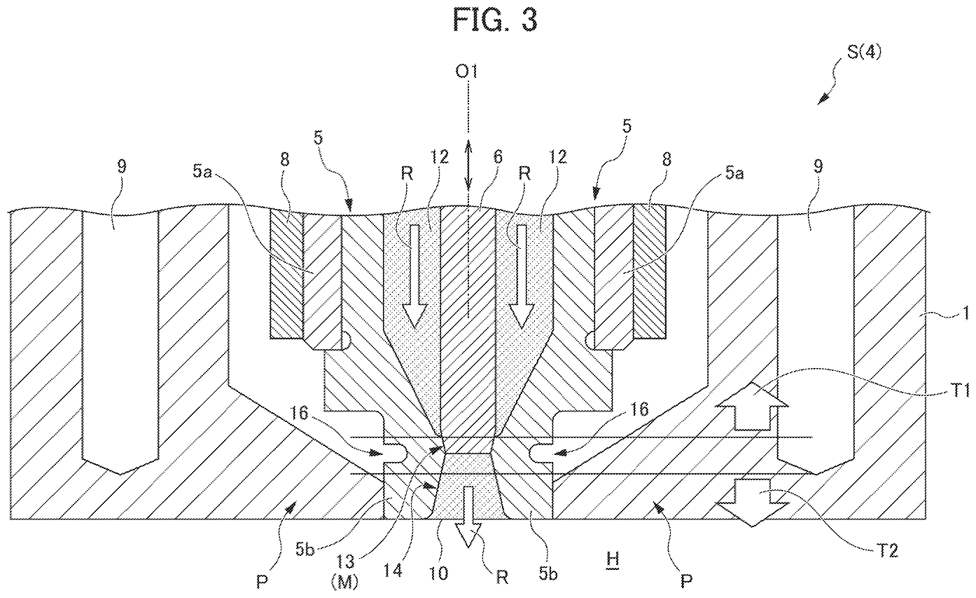

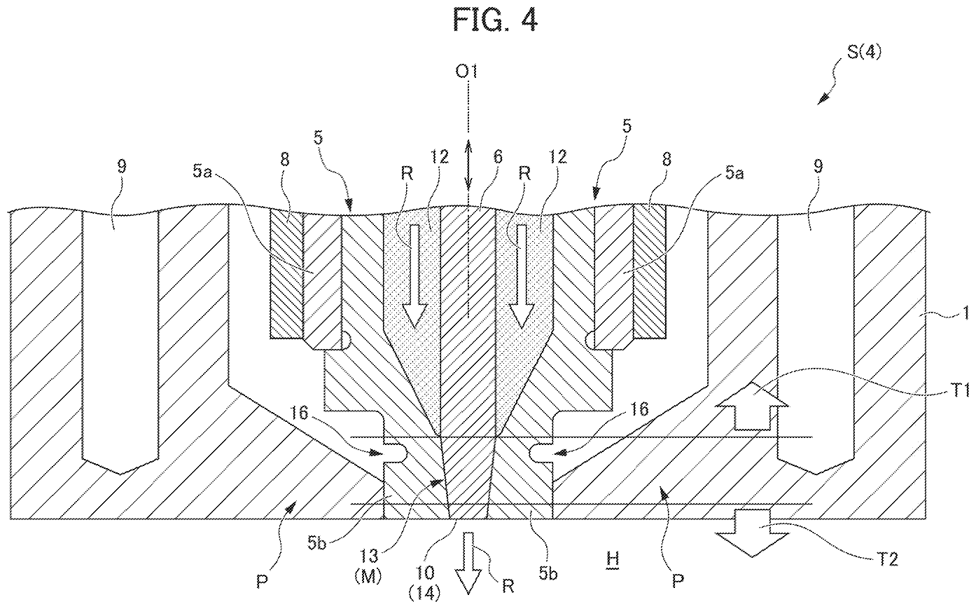

For example, even in the case in which the discharge part 14 is formed long in the axial O1 direction as illustrated in FIG. 3, or the injection structure 4 does not include the discharge part 14 as illustrated in FIG. 4, the same effects as in the present embodiment can be achieved even if other configurations are different, as long as the heat insulation groove 16 is provided so as to be recessed inward from the outer circumferential surface toward the axial line O1 and extends in the circumferential direction, on the outer circumference of the valve pin contact section M (valve opening/closing part 13). When the space for the discharge part 14 is reduced or eliminated, the molding material to be cooled is reduced as well, whereby the distance between the cooling surface and a surface potentially involving stringiness (valve pin tip) can be basically shortened; therefore, the heat insulation groove 16 adding to this feature can further prevent stringiness from occurring, and achieve further significant operating effects.

### PREFERRED MODE FOR CARRYING OUT THE INVENTION

1: fixed mold
2: movable mold
3: injection device
4: injection structure (valve gate structure)
5: hot runner nozzle
5a: nozzle body
5b: top nozzle
6: valve (valve pin)
10: discharge port
12: molding material flow path
13: valve opening/closing part
14: discharge part
16: heat insulation groove
A: injection molding device
H: cavity
M: valve pin contact section
O1: axis line
R: molding material
T1: molding material heat-insulating layer
T2: molding material cooling layer

1. An injection molding device comprising an injection structure of a hot runner system for injecting a molding material into a cavity of a fixed mold and a movable mold both clamped,
the injection structure comprising:
a hot runner nozzle including a heating part on an outer circumferential side, and a flow path extending from a rear end to a tip in an axial direction and communicating with the cavity; and
a valve pin arranged in the flow path of the hot runner nozzle, the valve pin capable of advancing/retracting in the axial direction, wherein a tip of the valve pin contacts with or separates from a valve opening/closing part provided on a tip side of the hot runner nozzle, thereby closing or opening the flow path,
wherein a heat insulation groove is provided to an outer circumference of a valve pin contact section, in which the valve opening/closing part of the top nozzle is formed, the heat insulation groove being recessed inward from an outer circumferential surface toward the axial line and extending in a circumferential direction.
